(19) United States
(12) Patent Application Publication
(10) Pub. No.: US 2015/0217981 A1
(43) Pub. Date: Aug. 6, 2015

(54) DETECTION AND WARNING SYSTEM UTILIZABLE IN A FALL ARRESTING AND PREVENTION DEVICE AND METHOD OF SAME

(71) Applicants: Paul D. Baillargeon, Suncook, NH (US); Van Walbridge, Arvada, CO (US)

(72) Inventors: Paul D. Baillargeon, Suncook, NH (US); Van Walbridge, Arvada, CO (US)

(21) Appl. No.: 14/608,341

(22) Filed: Jan. 29, 2015

Related U.S. Application Data
(60) Provisional application No. 61/934,617, filed on Jan. 31, 2014.

(51) Int. Cl. B66F 17/00

(52) U.S. Cl. CPC B66F 17/00

(57) ABSTRACT

A fall arresting/prevention warning device that interfaces with one or more sensors that may be non-invasive and not interfere with normal operation of an aerial lift. The sensors detect movement of an aerial lift work platform and warn the operator when movement of the aerial lift is detected in order to have the operator verify that safety precautions have been taken to safely operate the aerial lift. The warning device may further detect movement of the aerial lift and simultaneously receive signals from one or more detection sensors of safety devices mounted to the vehicle, boom, work platform, or operator to verify safe operation of the aerial lift and provide a warning to the operator only when the proper operational status of a safety device is not detected, reinforcing the necessity to adhere to safety precautions when operating the aerial lift.

### RELATED APPLICATION

This application claims the benefit of pending U.S. Provisional Patent Application No. 61/934,617 filed Jan. 31, 2014 entitled DETECTION AND WARNING SYSTEM UTILIZABLE IN A FALL ARRESTING AND PREVENTION DEVICE AND METHOD OF SAME which is hereby incorporated herein by reference in its entirety.

### FIELD OF THE INVENTION

The disclosed invention relates generally to a fall arresting/prevention warning device that interfaces with one or more detectors and sensors that may be installed external to aerial lift machinery and therefore without interfering with the electronics, hydraulics or other operational systems of the aerial lift vehicle or machinery. The non-invasive sensor devices detect movement of the aerial lift work platform, and transmit a signal to the warning device of the present invention. The warning device may warn the operator when movement of the aerial lift is detected. The warning from the device may be an alarm, a verbal instruction to the operator, a vibration, a visual warning and/or other clear indicator to the operator that the aerial lift is moving and the operator should therefore verify that safety precautions have been taken to safely operate the aerial lift. These safety precautions may be to verify the secure attachment of a safety lanyard to the operator, to secure of the door of the work platform, to check for adequate clearance of the aerial lift from surrounding structures, as well as other procedural safety requirements. When the warning device detects movement of the aerial lift, the device may simultaneously receive signals from one or more detection sensors of safety devices mounted to the vehicle, boom, work platform, or operator to verify safe operation of the aerial lift. As an example, the warning device may poll for the detection of the attachment of the safety lanyard when movement of the aerial lift is detected and may only provide a warning to the operator when the attachment of the safety lanyard is not detected, reinforcing the necessity to secure the safety lanyard when operating the aerial lift.

The operational movement of elevating construction machinery such as aerial lift work platforms, bucket trucks and similar type elevating work platforms is detected using movement detector that are attached externally and non-invasively meaning that the movement detectors do not tie in directly to any operational controls or electronics of the boom or machinery and therefore can be retrofitted to existing equipment or be installed on new equipment. The control receiver warning device interfaces with sensors such as an angle indicator, boom rest switch, pressure transducers or latching switches to detect any movement of the platform or bucket of an aerial lift device. The sensors may further be used to detect unsafe conditions such as excessive tilt or overload of the platform or bucket, or a dramatic change in weight of the work platform indicating an operator may have fallen from the platform. From the detection of an unsafe or dangerous fault condition, the control receiver warning device transmits an emergency warning signal to an operator, a supervisor and emergency personal through a wireless transmission. The warning device may further monitor, record, and store the operational movements and detection of signals and warnings from safety sensor devices to audit operation of the aerial lift and provide for opportunities to reinforce safety procedures for the operator.

### BACKGROUND OF THE INVENTION

Construction and aerial lift machinery apparatus present significant risks and danger not only to the operators, but to those in proximity to the machinery. To address these issues, safety devices such as lanyards or safety harness detection sensors, motion and high voltage proximity sensors and other warning devices to protect the operator have been developed. A remote monitoring device that is specific to the fall prevention and protection has been developed by the present inventors, Baillargeon et al. and is described in pending U.S. Patent Publication No. 2012/0217091. The invention discloses a monitoring system that delivers warning messages and critical information to aerial lift operators to remind and enforce safety regulations including the attachment of a safety lanyard prior to movement of the bucket of the aerial lift. An additional patent, U.S. Pat. No. 6,330,931, to Baillargeon and others describes a safety lanyard detection sensor and warning device which inhibits movement and operation of the machinery if the attachment of a safety lanyard is not detected. The device further provides visual or audible messages to the operator to connect the safety lanyard. Movement of the machinery may be inhibited until the connection of the safety lanyard is detected. A further patent to Baillargeon and others, U.S. Pat. No. 6,297,744, discloses a warning device that delivers messages to the operator to secure their safety lanyard at an initial upward movement of the work platform and delivers messages within the area below the boom and work platform or zone of danger that the boom is moving, expressing to persons below that they should remain out of the area as the boom descends.

In some of these patents and patent applications of the prior art, upward movement of the work platform is inhibited via an interlock switch that is electrically connected to the boom lift control system requiring extensive retrofitting to install the device on older or newer aerial lift equipment. The device attachment is therefore too invasive and costly to be readily adopted by manufacturers and operators within the aerial lift community. While there is significant risk to an unprotected lift operator that has not properly secured themselves to the work platform or that has not properly followed safety procedures, the invasive installation of some safety devices has created a barrier, and therefore what is needed is an easily installed and operational warning device that can be retrofitted to existing equipment or be implemented on new equipment at minimal costs.

### SUMMARY OF THE INVENTION

The present invention discloses an aerial lift control receiver safety data recovery and operator warning device that integrates with the following: the interface monitoring unit of the U.S. Patent Publication No. 2012/0217091 to Baillargeon et al.; the smart snap or other safety lanyard detection switch or smart snap warning system which is secured to a suspension harness as described in U.S. patent application Ser. No. 14/338,289 also to Baillargeon et al.; an anchor mount lanyard detector mounted on the basket or boom; and to telematics devices that identify an operator, location of a vehicle, fault conditions of the vehicle and other information. The warning device of the present invention is further a standalone safety fall/prevention system for warning an operator of movement of the aerial lift work platform and of other fault conditions. The receiver warning device may further detect the attachment of the safety lanyard or signals from other safety devices as soon as movement of the aerial lift work platform, basket or bucket is detected. The control receiver warning device of the present invention, further acts as a data recorder to detail and save the date, time, location and identification information of all operational movements, lanyard attachment and detachment, identified fault conditions and other information to properly determine safe operation of an aerial lift.

In a first embodiment, the fall arresting/prevention device of the present invention is a standalone control receiver warning device that is linked through a hard wired or wireless connection to one or more movement detectors and sensors that activate if movement of the aerial lift is detected. The standalone control receiver warning device and the wired or wirelessly integrated detection sensors may be installed and operational external to and without any requirement for any modification to the boom controls, electronics or mechanics of the truck, elevation machinery, or work platform and therefore can be retrofitted to old or new equipment. The standalone control receiver warning device and sensor system detects movement of the boom or platform and provides a warning to the operator that the aerial lift is moving and safety procedures such as verifying the attachment of the safety lanyard, securing the door lock and other steps must be performed. The notification from the standalone warning system may be through the transmission of an alarm, a verbal communication warning or instruction, a vibration, visual warning and/or other clear indicator to the operator that the system is moving and procedural safety steps must be taken. The standalone system may be of minimal size and be mounted or otherwise attached to the safety lanyard, work platform, along an upper or a lower portion of the boom lift, to the operator's safety harness, or to the clothing, helmet or hard hat of the operator to be close physically to the eyes and ears of the operator so that a warning is heard and clearly distinguished as a warning of movement of the aerial lift or other unsafe condition while operating the aerial lift.

In further embodiments, the receiver warning device integrates with the interface monitoring unit that is described in pending U.S. Patent Publication No. 2012/0217091 and with other safety devices. The interface monitoring unit provides a hard wired or wireless receiver that detects operational states and warnings from safety devices and transmits this information to the operator. The interface monitoring unit further includes data logging features that track telematics data specific to the operator and the aerial lift device including the time and operational steps taken before, during and after the failure to detect the connection of the safety lanyard or other fault conditions. This information is stored and transmitted to supervisors and others to monitor and track fault conditions and safety violations in the operation of an aerial lift device. The unit further provides data and warnings on severe fault conditions, such as an overload in the bucket, electrical power lines, excessive winds, outrigger stability warnings and other fault conditions and includes the transmission to emergency personal if a fault condition occurs where an operator may be in distress. The interface monitoring unit receives signals from safety devices that are equipped to transmit digital information through a hard wired or wireless connection. While most safety devices provide communication in an appropriate digital format for the interface monitoring unit, some mechanical systems only provide a read out on a display screen, a mechanical gage indicator and/or a warning signal that may not be properly identified by the operator. The control receiver warning device of the present invention integrates with analog and mechanical safety devices and indicators to indicate movement of the aerial lift and to transmit appropriate fault condition information to the interface monitoring unit. In this way, the interface monitoring unit and control receiver warning device may be used with older safety and movement detector devices without the necessity for replacement of these safety devices. As a standalone warning device, the control receiver receives and provides indicators or commands to communicate and translate movement of the aerial lift or fault condition signals from these devices to the operator.

As an integrated system, the control receiver warning device may be an electrical control receiver circuit within the interface monitoring unit, within the smart snap safety lanyard, or the anchor mounted lanyard detection system to enhance the operational characteristics by detecting movement of the aerial lift. The systems may then concurrently detect movement of the aerial lift and the attachment of the safety lanyard and if no connection is detected immediately broadcast a warning to the operator to attach the safety lanyard. A further transmission to a supervisor or other authority may be sent and the fault condition of movement without attachment may be recorded and stored using a microprocessor, memory and data storage devices within the electrical circuitry of the control receiver warning device and/or interface monitoring unit. If a safe condition is detected such as the connection of the safety lanyard to the anchor mount, the integrated warning device may not provide a warning but may instead only record and store the operational movement of the aerial lift, the attachment of the safety lanyard and other processes performed by the work platform and aerial lift system such as up and down movements as indicated by the detection sensors communicating with the warning device. The control receiver warning device may further identify and record the identity of the operator and the aerial lift unit, and provide a time stamp, date and location to track the operation of the aerial lift system. This information may be stored within the device to be downloaded, or be transmitted to an external server.

The integrated or standalone control receiver warning device of the present invention communicates with external detection sensors positioned on the vehicle, boom assembly, and/or elevating machinery to determine movement, angle of incline, angle of gradient, hydraulic pressure, and other indicators that will assist in determining safe operation of an aerial lift. Importantly, the warning system of the present invention provides several ways to monitor aerial lift operation and movement without requiring any electrical connection, interference or interruption of the boom lift control panel and normal operation of the mechanical boom of the aerial lift. In this way no modifications need to be made to the vehicle's boom lift control system or other support systems in order to use the control receiver warning device and detection sensor system as a standalone, with the interface monitoring unit or with a safety lanyard detector to detect movement of the work platform. The control receiver warning device and detection sensor system can therefore be retrofitted to older equipment without having invasive or tied in electrical connections to the operational controls of the machinery or interfering with normal operation of the aerial lift.

The present invention is related to a safety warning device for warning an aerial lift operator of movement of an aerial lift apparatus comprising at least one detection sensor affixed to an aerial lift apparatus; a warning device affixed for receiving data from the at least one detection sensor; and wherein the at least one detection sensor senses movement of the aerial lift apparatus and transmits a signal to the warning device activating the warning device to transmit a warning of movement to an operator of the aerial lift apparatus. The safety warning device may further comprise a plurality of equipment condition detectors located on the aerial lift apparatus and communicating with the warning device and the transmitted signal detecting movement activates the warning device to simultaneously poll the plurality of equipment condition detectors located on the aerial lift apparatus to detect fault conditions. The plurality of equipment condition detectors may include a safety lanyard detector for each operator of the aerial lift and the warning device transmits a warning if the attachment of any operator's safety lanyard is not detected. The plurality of equipment condition detectors may also include a work platform door latch detector and the warning device transmits a warning if the attachment of the work platform door latch detector is not detected.

The safety warning device for warning an aerial lift operator of movement of an aerial lift apparatus further comprises an independent power source for the warning device to electrically insulate the warning device from electrical continuity with other portions of the aerial lift apparatus. The safety warning device for warning an aerial lift operator of movement of an aerial lift apparatus may further include a data server for at least one of receiving, storing and transmitting data from the warning device; and the data server is provided with at least one information logging database and data received by the data server from the warning device is input to the database and organized according to predetermined categories. The safety warning device transmits the operational movement data and the status of the plurality of equipment condition detectors to the data server and the data is recorded in the appropriate predetermined category in the information logging database. The safety warning device further transmits the identity of one or more operators of the aerial lift and this information is recorded and the status of each operator is transmitted to the data server and recorded in the appropriate predetermined category in the information logging database. The safety warning device may further be integrated with a GPS receiver and capable of continually receiving, storing and transmitting of operational conditions and telematics data for the aerial lift apparatus.

The present invention is further related to a method of warning an aerial lift operator of movement of an aerial lift comprising the steps of detecting movement of an aerial lift apparatus using at least one detection sensor affixed to an aerial lift apparatus; receiving a signal from the at least one detection sensor when movement is detected; and activating a warning device when the signal is received to transmit a warning of movement to an operator of the aerial lift apparatus. The method of warning an aerial lift operator of movement of an aerial lift may further comprise the step of locating a plurality of equipment condition detectors on the aerial lift apparatus to communicate with the warning device. Locating the plurality of equipment condition detectors may include the step of locating a safety lanyard for each operator of the aerial lift and the method may include the step of polling for the attachment of the safety lanyard of each operator using the warning device when movement of the aerial lift is detected. Locating the plurality of equipment condition detectors may include the step of locating a work platform door latch detector and the method may include the step of polling for the latching of the work platform door latch detector using the warning device when movement of the aerial lift is detected. The method of warning an aerial lift operator of movement of an aerial lift may further comprise the step of powering the warning device using an independent power supply. The method of warning an aerial lift operator of movement of an aerial lift may also further comprise the steps of receiving, storing and transmitting data to a data server from the warning device; and the data server may be provided with at least one information logging database and data received by the data server from the warning device may be input to the database and organized according to predetermined categories.

The present invention is further related to a safety warning device for an aerial lift apparatus comprising at least one movement detector; a warning device in communication with the at least one movement detector; and wherein the at least one movement detector detects movement of the aerial lift apparatus and transmits a signal to the warning device activating the warning device. The warning device of the safety warning device for an aerial lift apparatus may issue a warning of movement of the aerial lift when activated. The movement detector of the safety warning device for an aerial lift apparatus may be attached to the aerial lift apparatus without interfering with the electronics, hydraulics or other operational systems of the aerial lift apparatus. The movement detector of the safety warning device for an aerial lift apparatus may be an angle indicator and the angle indicator may be attached to one of at least a lower boom, an upper boom and bucket pivot of the aerial lift apparatus. The movement detector of the safety warning device for an aerial lift apparatus may be a control cover with a control access switch, a control lever with a control access switch, a pressure transducer, a motion detector that may have a video camera, and/or a boom rest switch detector. The safety warning device for an aerial lift apparatus may comprise a plurality of safety sensor devices in communication with the warning device. The safety warning device for an aerial lift apparatus when activated may poll the safety sensor devices to detect fault conditions. The safety warning device when activated may issue a warning if a fault condition is detected. The safety sensor devices of the safety warning device for an aerial lift apparatus may include a safety lanyard detector for each operator of the aerial lift and the warning device may detect a fault condition if the attachment of any operator's safety lanyard is not detected and may issue a warning. The safety sensor devices of the safety warning device for an aerial lift apparatus may include a work platform door latch detector and the warning device may detect a fault condition if the door latch is not secured and may issue a warning. The safety warning device for an aerial lift apparatus may further comprise a plurality of equipment condition detectors in communication with the warning device. The plurality of equipment condition detectors may include at least one angle indicator on the chassis of the aerial lift apparatus and wherein the warning device may detect a fault condition if the measured angle changes during operation of the aerial lift and may issue a warning. The safety warning device for an aerial lift apparatus may further comprise an independent power source for the warning device to electrically insulate the warning device from electrical continuity with other portions of the aerial lift apparatus. The safety warning device for an aerial lift apparatus may further comprise a microprocessor, memory and data storage for at least one of receiving, storing and transmitting data from the warning device.

The present invention is further related to a method of warning an aerial lift operator of movement of an aerial lift apparatus may comprise the steps of detecting movement of an aerial lift apparatus using at least one movement detector that is attached non-invasively to the aerial lift apparatus without interfering with the electronics, hydraulics or other operational systems of the aerial lift apparatus; receiving a signal from the at least one movement detector when movement is detected; and activating a warning device when the signal is received to transmit a warning of movement to an operator of the aerial lift apparatus.

The method of warning an aerial lift operator of movement of an aerial lift apparatus may further comprise the step of polling a plurality of safety sensor devices and equipment condition detectors in communication with the warning device to detect fault conditions; and issuing a warning if a fault condition is detected.

These and other features, advantages and improvements according to this invention will be better understood by reference to the following detailed description and accompanying drawings.

### BRIEF DESCRIPTION OF THE DRAWINGS

Several embodiments of the present invention will now be described by way of example only, with reference to the accompanying drawings in which:

FIG. 1 is a diagrammatic representation of an embodiment of the control receiver warning device of the present invention as a standalone unit that interfaces with detection sensors mounted on the snap hook of a safety lanyard and an angle indicator to determine movement of the aerial lift;

FIGS. 2A and 2B are diagrammatic representations of an embodiment of the control receiver warning device of the present invention with an embodiment of a cover detector that signals access of the aerial lift operational controls;

FIG. 3 is a diagrammatic representation of an embodiment of a detection sensor as a master grip switch that interfaces with the control receiver warning device of the present invention to detect movement of the aerial lift operational controls;

FIG. 4 is a diagrammatic representation of embodiments of detection sensors as a hydraulic pressure transducer and as an angle encoder that interface with the control receiver warning device of the present invention to detect movement of the aerial lift;

FIG. 5 is a diagrammatic representation of an embodiment of a detection sensor as a proximity motion detector or a video sensor that interfaces with the control receiver warning device of the present invention to detect movement of the aerial lift;

FIGS. 6A-6D are diagrammatic representations of an embodiment of a detection sensor as a boom rest sensor switch that interfaces with the control receiver warning device of the present invention to detect movement of the aerial lift; and

FIGS. 7A and 7B are diagrammatic representations of embodiments of detection sensors as angle detectors on the chassis of a vehicle that interfaces with the control receiver warning device of the present invention.

### DETAILED DESCRIPTION OF THE INVENTION

The standalone or integrated control receiver warning device detects movement of the aerial lift through the use of detection sensors that may be optical, video, or electronic sensors and/or mechanical switches attached to the vehicle, boom, arm, hydraulics, basket or bucket, work platform or other locations on the aerial lift machinery. The detection of up or down movement may also be determined by interfacing an angle indicator, pressure transducer or latching switch with the control receiver warning device to indicate the direction of movement aerial lift as described herein. A signal is transmitted from the detection sensor to the control receiver warning device when a sensor exceeds a prescribed threshold or a switch or other mechanical or electronics mechanism triggers each due to movement of the aerial lift. The control receiver warning device broadcasts a reminder warning using an audio alarm, a verbal instruction, a vibration or a flashing light signal to alert the operator that the boom motion is detected by the motion sensors. The warning provides a reminder to the operator to verify a fall protection harness is properly secured to the operator, the safety harness lanyard is connected to the boom anchor mount, the basket door is properly latched and other safety protocols have been followed. In this first embodiment, the control receiver warning device interfaces only with one or more detection sensors affixed to the aerial lift machinery to simply indicate movement and provide a warning to reinforce the required safety steps that must be taken and checked to safely operate the aerial lift. The standalone device with a single detection sensor can therefore be easily retrofitted to the machinery without invasive tied in connections to the electronics or mechanics of the machinery and without interference with normal operation of the aerial lift system. The standalone warning device may further be easily attached to the boom, the work platform, the uniform or other clothing, the hard hat, the fall protection harness or the boom rest to provide an easily recognizable audible, verbal, and/or visual warning to the operator to verify safety steps prior to operation of the aerial lift. The standalone may further record the detection of movement and integrate with a telematics system of a vehicle to supplement operational data on the identity of each of the lift operators, where some work platforms will support more than one operator, aerial lift unit, date, time and location.

In further embodiments, the control receiver warning device is integrated with other safety devices on the aerial lift machinery such as a safety lanyard detection system. In this embodiment the control receiver warning device concurrently polls and detects the attachment of the safety lanyard of each operator of the aerial lift when movement is detected. The detection of the attachment of the safety lanyard during movement may be limited to the initial movement of the aerial lift, or may be continuous where any failure to detect during movement results in an audible, verbal or other type of warning being emitted indicating the safety lanyard is not attached. In this manner an operator is warned that the safety lanyard should not be detached at any time during operation of the aerial lift. This prevents a serious accidental fall from occurring for example because an operator removes the safety harness such as to increase his or her reach out of the basket or platform while operating the aerial lift.

The control receiver warning device detects and monitors the up and down motion of the aerial lift using the detection sensors and detects the attachment of the safety lanyard detector without any electrical or invasive connection to the lift controls or vehicle. The control receiver warning device will further interface with anchor mount safety lanyard detectors and Smart Snap detectors that are within the snap hook of the safety lanyard. The control receiver warning device may be integrated with an interface monitoring unit, the safety lanyard snap hook, the anchor mount or be a standalone unit that is easily installed at the boom end, on the bucket or work platform, or be affixed to the safety harness, clothing, helmet or hard hat of the operator. The standalone control receiver warning device is battery powered or may be powered from the vehicle power source and includes a wireless receiver to receive the detection sensor signals or optionally can be hard wired to one or more of the detection sensors that are installed to detect up and down movement of the aerial lift and boom. Because the standalone control receiver has the advantage of not requiring any connection to the lift controls and is battery powered and may be rechargeable or be connected to a vehicle power source, the system will work with insulated lifts and not interfere with the insulated requirements.

The control receiver warning device can also be programmed to issue an alarm or verbal command through the integration with the telematics system of the vehicle and/or with other equipment condition detectors to warn the operator of other critical operating conditions that may cause a risk to safety including: low tire pressure from wireless tire pressure monitoring systems; outriggers improperly positioned; the chassis of the vehicle at an angle that is not safe; the improper attachment of the fall protection harness; a basket door not securely closed; excessive weight in the basket or on the boom that is above an overload threshold of operable weight; the parking brake not being set properly; and any dangerous condition or change in the reading from these safety devices that may be continual or intermittently monitored. The control receiver warning device will also record operations of the lift, the attachment and detachment of the safety lanyard, and other operational and fault conditions and may include a wireless transmitter and/or have a USB or other communications port to download this information to a server. By recording the operations of the lift and attachment of the safety lanyard a correlation can be done to determine that each time the lift was moving the safety lanyard was attached. This analysis may further show where an operator left one end attached continuously even when the aerial lift was not in operation in order to avoid receiving an alarm. Other operational conditions may be monitored and used forensically in the event of an accident.

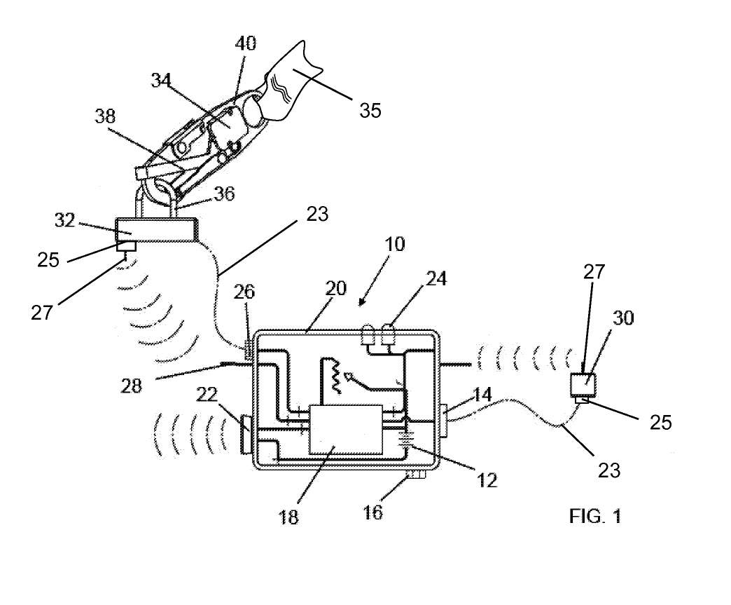

There will be several ways for the control receiver warning device to detect the up and down motion of the lift and the attachment of the safety lanyard without interfering with the operational controls of the aerial lift. As a standalone device, the control receiver 10 shown diagrammatically with its components in FIG. 1, has an independent power source such as a battery 12 that optionally could be a rechargeable battery that is recharged through a USB port 14 or other connection as is commonly known in mobile devices. Alternatively, the receiver 10 may have a power adaptor connection 16 and connect to a 12 volt power supply at the boom end or use another available power source on the bucket or work platform. The control receiver electronics module 18 is installed within an environmentally resistant casing 20 that supports the electrical components and connectors within the receiver 10. A speaker 22 is affixed to or supported within the casing 20 to provide an audible alarm or verbal commands. One or more LED indicator lights 24 may be used as diagnostic indicators to show power on, battery usage, or fault conditions where for example the light may blink to denote a safety hazard, low battery or denote a failure of signal reception by the receiver from one or more available detection sensors. An initial diagnostic will link to all available detection sensors and various display colors such as green, yellow and red from the LED indicators will provide continuous verification for the operator that the available links are operational. The available detection sensors may be connected through a hard wired connection using the USB port 14, or a multi-pin connector 26 such as a DIN, serial, parallel or other standard connector used as the output and communication port on a particular sensor or detector device. Currently, many standard detector devices are simply a mechanical display such as an angle indicator that moves a mechanical pin across a gage as the device is rotated, thereby providing only a visual indication of the angle of incline of the aerial lift. Within the scope of the present invention is the integration of wireless communication between the control receiver 10 and many devices that normally are designed with an internal visual display using a mechanical indicator or a LCD or LED screen, and that functionally do not record or send data from the device. The control receiver 10 may provide an adaptable data transmitter interface 25 that connects directly to the movement detector or sensor device through a hard wire 23 connection or that uses a wireless connection with a transmitter 27 to receive signals from the device. The data transmitter interface 25 reads and/or interprets data from the sensor device and sends this information to the receiver 10 where the data is recorded and acted upon based on triggers, thresholds and acceptable operational windows. The control receiver 10 may further integrate data received from fault condition detectors and sensors in order to warn the operator of unsafe or potentially unsafe conditions.

As shown in FIG. 1, a movement detector may be in the form of an angle indicator where a reading from the angle indicator 30 may exceed a threshold of 0° indicating that the articulating arm of the aerial lift is moving. The angle indicator 30 may be a mechanical indicator or may be a digital solid state electrical indicator device with either indicator being connected using a wire 23 through the USB port 14 for example or by transmitting a wireless signal to an antenna 28 of the receiver 10. Upon detection of movement, the control receiver warning device 10 broadcasts a reminder warning alerting the operator to verify safety procedures such as verifying the secure attachment of the safety lanyard to the operator and work platform. In a further embodiment, the receiver 10 may continuously poll or upon receiving a trigger from the angle indicator 30 proceed to poll the safety lanyard anchor mount detector 32 to determine if the snap hook 40 of the safety lanyard 35 is connected. The control receiver 10 may further poll the snap hook detector 34 installed to the snap hook 40 at each end of the safety lanyard to confirm that the first end is activated and connected to an anchor 36 affixed to the bucket or boom of the aerial lift and a second end is connected to the operator. The activation of a lanyard snap 38 or switch as described in U.S. Provisional Patent Application No. 61/857,672 also to Baillargeon et al. indicates that the snap hook 40 is affixed to the anchor 36. If a connection is not detected at the anchor mount 32 or at one or both snap hooks 40, the control receiver warning device 10 is activated and issues or broadcasts an alarm such as using audible, verbal, and/or visual indicators to alert the operator that an unsafe condition exists or more specifically that the safety lanyard 35 is not attached. Similarly, upon receiving a single from the angle indicator 30 or other sensor device indicating that the aerial lift is moving, the control receiver warning device 10 may further poll the door latch sensor on the bucket or work platform to detect that it is secure and that the door is latched or issue a warning if the door latch is not detected. Other safety detectors such as an overload or angle of gradient detector may also be integrated with the control receiver 10 to provide alerts as fault conditions indicate, particularly when the bucket or work platform is in operation and moving.

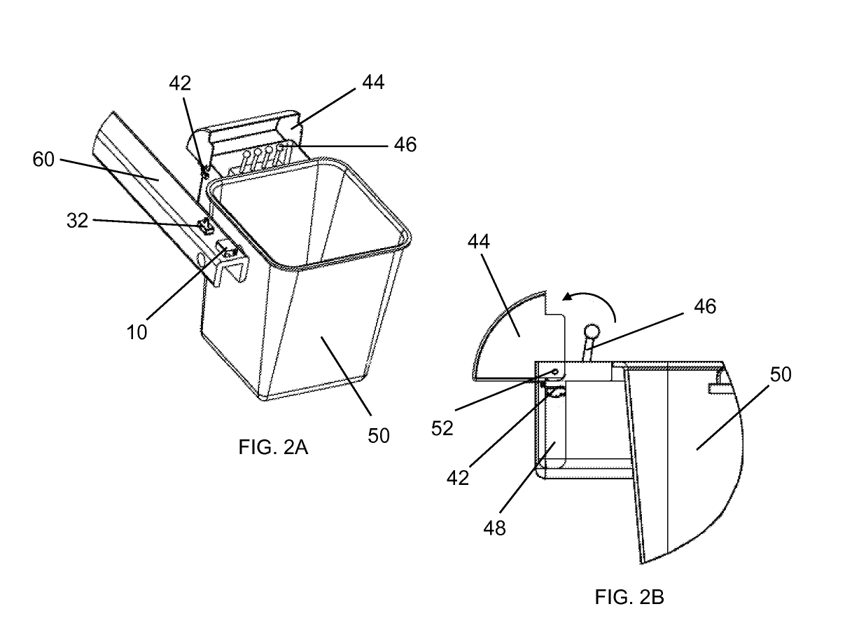

The control receiver 10 may optionally or additionally receive boom operation or key input data that will indicate the operator is ready to activate the controls. As shown in FIG. 2A, the movement detector may detect the movement of a boom control cover 44 or a security locking bar (not shown) that will not allow access or movement of the boom control levers 46 until the cover 44 or security bar is relocated to the operating position such as by lifting and rotating the cover up as indicated by the arrow in FIG. 2B. The movement of the cover 44 or security bar triggers a control access switch 42 acting as the movement detector that sends a wireless or hard wired signal to the control receiver 10 indicating that the controls 46 of the aerial lift are available and movement may be imminent. The control receiver 10 receives the signal and polls for the detection of the safety lanyard, door latch or the condition of other sensor detectors emitting an alarm if an improper condition such as if the lanyard connection is not detected. The opening and closing of the cover and detection or warning signal may be recorded and be stored in memory devices on the control receiver warning device 10 with a time and date stamp to determine infractions by an operator when using the aerial lift. The cover 44 or security bar may be installed to a support 48 of the bucket 50 using a pin 52 or other attachment mechanism that provides for the cover to pivot and provide access to the controls 46 but that does not interfere with movement of or within the bucket 50 or the operation of the controls 46. The switch 42 may be a mechanical trigger that activates from the movement of the cover 44, or be an optical sensor, Hall Effect sensor or other electronic sensor that detects and sends a signal each time the cover 44 is opened or closed. The activation signal the switch 42 may be sent to the control receiver 10 through a hard wired connection or if used in insulated aerial lift buckets and machinery through a wireless connection.

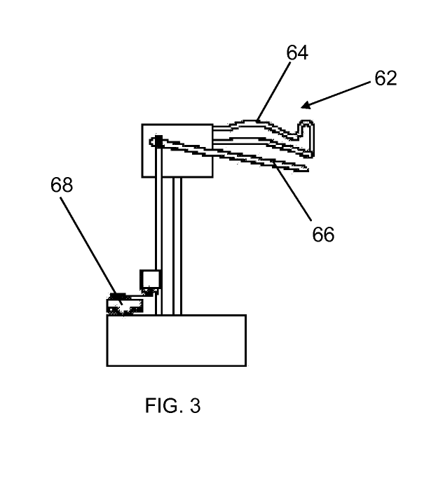

Another non-invasive movement detector within the scope of the present invention is an activation switch on a master control (dead man) that is incorporated as a single lever control. As shown in FIG. 3, many aerial lift devices require that the operator activate and maintain in an operational position a master control 62 while operating one or more directional controls that move the aerial lift up, down, left or right. In a first embodiment, the master control 62 may be a joystick having a handle grip 64 that the operator can rest a palm on and maintain an operational position by pressing down on the control 62. The activation control lever 66 extends beneath the master control 62 and is activated by the compression of the master control 66. The activation triggers an electrical, mechanical, or optical control access switch 68 and a signal is sent to the control receiver warning device 10 indicating the aerial lift controls have been activated. The signal from the control access switch may be sent through a hard wired connection to the control receiver 10 or through a wireless connection particularly when used on insulated aerial lift buckets and machinery. As noted above, the control receiver warning device 10 may issue a reminder warning or interface with other safety sensor devices and poll for the detection of these devices such as the safety lanyard attachment, the bucket door latch, and other safety requirements and provide an alert of any fault condition. The activation control lever 66 will not monitor movement of the boom 60 but will trigger the control access switch if the operator unlocks the controls or activates the master control (dead man). Each time the control access switch 68 is activated, the activation signal is transmitted through a hard wired or wireless connection additional data may be determined and stored by the control receiver warning device 10. This additional data may include telematics information such as the date, time, operator, and location of the aerial lift that may be collected from a telematics system on the vehicle, or through a connection of the control receiver warning device 10 to a database server.

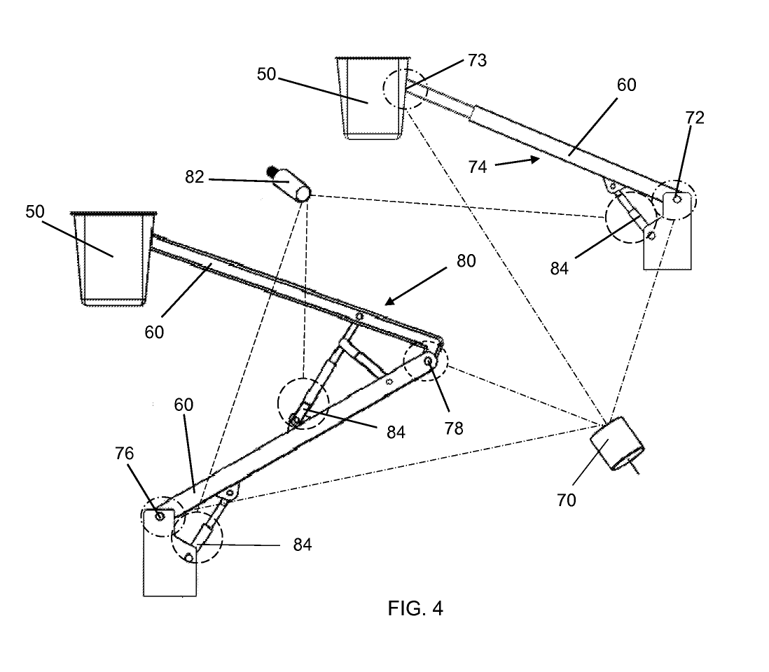

In some embodiments, boom movement, up and down, can be indicated in several ways using various detection sensor devices. The movement detector may be an angle encoder 70, as shown in FIG. 4, may be located at the boom pivot 72 at the base on a telescopic boom 74 or at each of the boom pivots 76 and 78 on an articulated boom 80. The angle encoder 70 detects each angular position of the boom 60 and may send a continuous or intermittent reading of the angle. The control receiver 10 using programmable software implemented on a microprocessor having memory and storage devices within the control receiver electronics module 18 detects if the angle is increasing for example between 0° and 90° meaning the aerial lift is moving in an upwards direction or decreasing meaning the aerial lift is moving in a downwards direction. For some articulating booms, the angle encoder 70 may detect any range of positions of the boom where an angle encoder 70 on a lower boom may measure angles in a range from 0° to more than 100° and an angle encoder on an upper boom may measure angles up to 230° with the control receiver 10 collecting information from one or more encoders separately and combine this information to determine movement and the position of the aerial lift. Through encoder counts further analysis can be performed based on presets to determine height estimates of the aerial lift. Any change in the angle is sent as an electrical signal from the encoder sensor device 70 using a hard wired or wireless connection to indicate that the aerial lift is moving. As noted, above upon receiving the signal, the control receiver 10 may perform a safety check for the detection of the connection of the lanyard, the securing of the door latch and safe condition status of other safety sensor devices and equipment condition detectors and issue an alarm if a fault or unsafe condition is detected. An angle encoder 70 may further be installed at the bucket pivot 73 to determine left and right movement of the aerial lift and transmit a signal to the control receiver 10.

An optional or additional detection sensor device may be a pressure transducer 82 that is installed at the elevation cylinder 84 and/or within the hydraulic pressure system. The pressure transducer 82 will transmit a signal if the pressure within the system increases to pressurize the cylinder 84 for up or down movement of the aerial lift. The pressure transducer 82 may be incorporated into a vehicle's telematics system to receive and track pressure measurements within the hydraulic system where telematics is more frequently incorporated into aerial lift equipment with a growing percentage of new utility vehicles. However commonly, the information is transmitted to a data recovery system and not easily accessible to an operator. By receiving a signal indicating a change in pressure from the pressure transducer 82, the control receiver warning device 10 may poll the sensor devices and issue or broadcast alerts that the aerial lift is moving or may provide an alert to an operator indicating an unacceptable pressure reading that is outside of a tolerance range in order to assist in the determination of a mechanical fault or overload condition within the hydraulics system of the aerial lift.

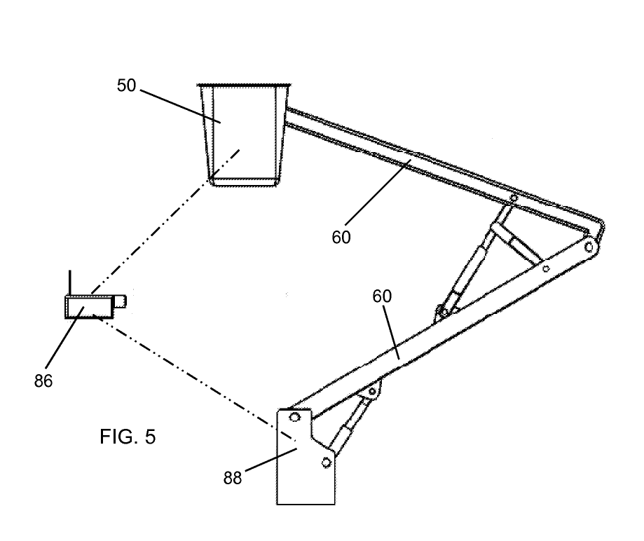

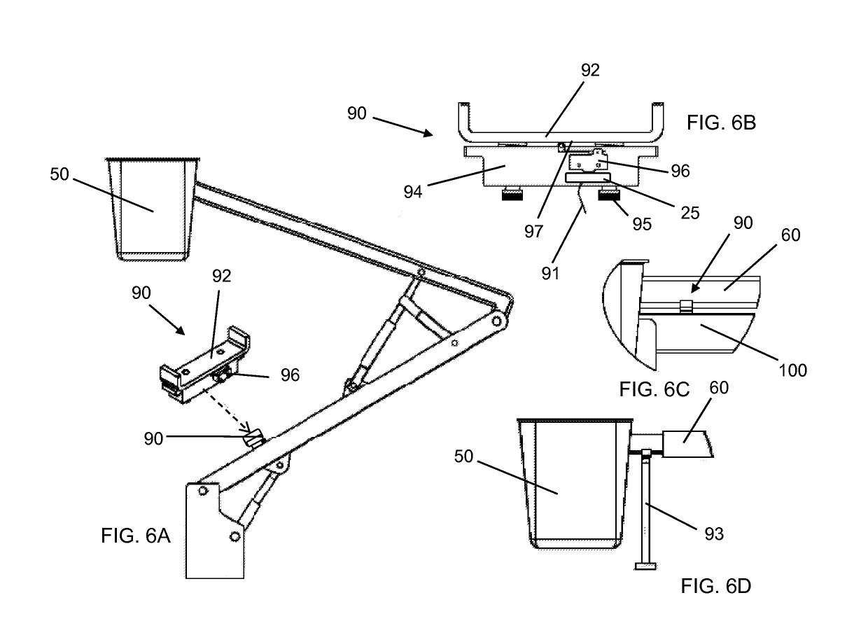

Motion or proximity detectors or video cameras may also available to detect movement of equipment and may transmit this movement to the control receiver warning device 10. A motion detector 86, as shown in FIG. 5, may be located within the bucket 50 or on the work platform or at the base 88 of the lift in order to detect up or down motion of the boom 60. The motion detector 86 may be wireless or hard wired and any detected movement will send a signal to the control receiver warning device 10. The motion detector 86 may sense movement using magnetics, light, electronics, radar or mechanical indicators. The motion of the aerial lift may further be detected by monitoring the activation of a boom rest switch 90 that is mounted below the boom 60 as shown in FIGS. 6A-6D and that transmits a signal to the vehicle that the boom 60 is in a lowered, rest position. The boom rest switch 90 has a channel bracket 92 that is mounted on a support 93 that extends from the rear chassis 100 of the vehicle. The bracket 92 is mounted on a base 94 supported on springs 95 that are normally not in tension, but are compressed by the weight of the boom 60 in a rest position sending an electrical signal through a wire 91 extending through the support 93 of the vehicle indicating the boom is fully down and in a stopped position. Within the scope of the present invention, a pressure switch detector 96 is affixed with a spindle arm 97 that is in tension from the weight of the boom rest bracket 96 and boom 60 when the boom is in the fully down and stopped position. If the boom 60 elevates and removes pressure from the boom rest bracket 92, the spindle arm 97 is out of tension triggering the mechanical or pressure switch detector 96 and using the adaptable data transmitting interface 25 to send signal through a wired or wireless connection to the control receiver warning device 10 that the boom is in an up position and therefore moving. The spindle arm 97 will trigger and the pressure switch 96 will send a signal when the boom moves up from the boom rest switch or down to return to a fully down non-moving position. The boom rest indicator 90 and/or the pressure switch detector 96 can also send signals to the driver if the vehicle is moving and the boom 60 is not stored at rest properly.

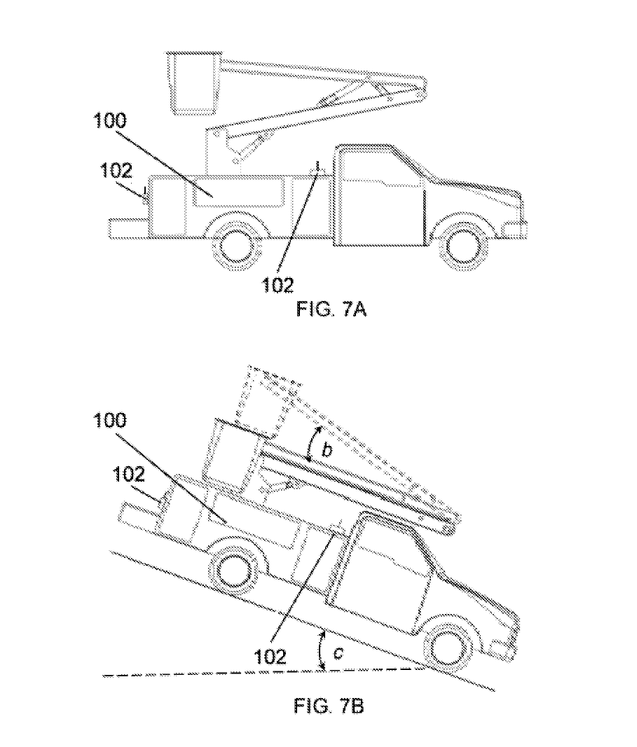

An angle indicator shown in FIG. 1 may also detect if the aerial lift vehicle is parked on a hill. One or more angle indicators 102 (one front to back, one right to left) will be mounted on the vehicle chassis 100 as shown in FIGS. 7A and 7B and will communicate to the control receiver warning device 10. If needed, the angle indicators 102 may be powered by the 12 volt power system from the vehicle. The angle of the vehicle or gradient will be sent through a wireless or hard wired connection to the control receiver warning device 10 and be used to calculate a relative zero angle when combined with the data from one or more of the angle indicators 30 mounted on aerial lift to indicate boom movement as opposed to just a change in the detected angle due to the incline. If the vehicle is parked on a hill, by using the angle of the chassis c to calculate a relative zero, the triggering of the alarm needlessly will be avoided. In calculating the relative zero angle, the angle of the chassis c will be deducted from the angle of the boom b until the boom 60 reaches the preset angle of movement. The chassis angle indicator 102 adjusts the boom angle indicator to avoid a premature alarm and senses the correct boom angle to warn the operator. The control receiver warning device 10 will store the chassis angle c and the date and time of operation. The system can also warn the operator or communicate with the telematics system of an unsafe angle of the chassis for operation of the lift. An unsafe angle of operation can result in the chassis leaning or tipping or cause outriggers that are extended from the chassis to bury themselves in dirt during operation. The control receiver 10 can monitor the chassis angle and provide a warning if there are changes during operation of the aerial lift.

The detection sensors and analyzers may further determine environmental conditions in the proximity of the aerial lift with signals from the analyzers being transmitted to the standalone control receiver warning device 10 or to the integrated control receiver warning device within the interface monitoring unit to warn the operator of dangerous conditions in addition to fall protection. These other conditions include a determination of the aerial lift position using the angle encoders 70, pressure transducers 82 and angle indicators 30 that will determine if the work position is overloaded or unstable or at a distance that is too close to high tension power lines. The safety warning device 10 of the present invention may further detect a change in height as movement of the boom 60, and further detect if the safety lanyard is attached to the bucket 50 or work platform through monitoring a snap hook detector 34. If the attachment of the safety lanyard is not detected, warnings may be verbal, visual and sonic alarms with different levels of intensity to indicate the severity of the unsafe condition.

Other electrical warning devices may be mounted on the boom 60 or can be strapped to the operator. These devices provide a sonic alarm and may also transmit a signal that could also be integrated through a wireless connection with the warning system 10 of the present invention to collect data. The control receiver warning device 10 will monitor if an operator properly responds to the warning by detecting the movement and direction up or down of the bucket 50 and simultaneously the state of one or more safety detectors. For example, if the control receiver warning device 10 does not detect an appropriate avoidance maneuver when a signal is received from a high voltage proximity detector, the present invention will provide a sonic alert warning of the danger. Data from these sensors and alarms can also be recovered from using the microprocessor, memory and data storage devices within the control receiver electronics module 18 of the control receiver warning device 10 to forensically investigate the cause of an accident. The safety warning system of the control receiver warning device 10 of the present invention evaluates a fault condition issued by a sensor within the status of the operating parameters of the aerial lift and the environmental conditions at the time of the incident and issues or broadcasts warnings to the operator while recovering live data or forensic data to be used for training, prevention and operational improvements. Importantly, while data recovery is now available to the maintenance and operations of a company, there is not available in the prior art live communications to the operator. The control receiver warning device 10 with detection sensors that may be non-invasive and the interface monitoring unit of the inventor's earlier patent applications provide this information to an operator to assist in avoiding an accident or tragic situation in operating an aerial lift system.

The invention has been described in detail with particular reference to certain preferred embodiments thereof, but it will be understood that variations and modifications can be effected within the spirit and scope of the invention.

What is claimed is:

1. A safety warning device for an aerial lift apparatus comprising:
at least one movement detector;
a warning device in communication with the at least one movement detector; and
wherein the at least one movement detector detects movement of the aerial lift apparatus and transmits a signal to the warning device activating the warning device.

2. The safety warning device for an aerial lift apparatus of claim 1 wherein the warning device issuing a warning of movement of the aerial lift when activated.

3. The safety warning device for an aerial lift apparatus of claim 1 wherein the movement detector is attached to the aerial lift apparatus without interfering with the electronics, hydraulics or other operational systems of the aerial lift apparatus.

4. The safety warning device for an aerial lift apparatus of claim 1 wherein the movement detector is an angle indicator.

5. The safety warning device for an aerial lift apparatus of claim 4 wherein the angle indicator is attached to one of at least a lower boom, an upper boom and bucket pivot of the aerial lift apparatus.

6. The safety warning device for an aerial lift apparatus of claim 1 wherein the movement detector is a control cover with a control access switch.

7. The safety warning device for an aerial lift apparatus of claim 1 wherein the movement detector is a control lever with a control access switch.

8. The safety warning device for an aerial lift apparatus of claim 1 wherein the movement detector is a pressure transducer.

9. The safety warning device for an aerial lift apparatus of claim 1 wherein the movement detector is a motion detector.

10. The safety warning device for an aerial lift apparatus of claim 9 wherein the motion detector has a video camera.

11. The safety warning device for an aerial lift apparatus of claim 1 wherein the movement detector is a boom rest switch detector.

12. The safety warning device for an aerial lift apparatus of claim 1 comprising a plurality of safety sensor devices in communication with the warning device.

13. The safety warning device for an aerial lift apparatus of claim 12 wherein the warning device when activated polls the safety sensor devices to detect fault conditions.

14. The safety warning device for an aerial lift apparatus of claim 12 wherein the warning device when activated polls the safety sensor devices to detect fault conditions and issues a warning if a fault condition is detected.

15. The safety warning device for an aerial lift apparatus of claim 12 wherein the plurality of safety sensor devices includes a safety lanyard detector for each operator of the aerial lift; and
wherein the warning device detects a fault condition if the attachment of any operator's safety lanyard is not detected and issues a warning.

16. The safety warning device for an aerial lift apparatus of claim 12 wherein the plurality of safety sensor devices includes a work platform door latch detector; and
wherein the warning device detects a fault condition if the door latch is not secured and issues a warning.

17. The safety warning device for an aerial lift apparatus of claim 1 comprising a plurality of equipment condition detectors in communication with the warning device.

18. The safety warning device for an aerial lift apparatus of claim 17 wherein the plurality of equipment condition detectors includes at least one angle indicator on the chassis of the aerial lift apparatus; and
wherein the warning device detects a fault condition if the measured angle changes during operation of the aerial lift and issues a warning.

19. The safety warning device for an aerial lift apparatus of claim 1 further comprising an independent power source for the warning device to electrically insulate the warning device from electrical continuity with other portions of the aerial lift apparatus.

20. The safety warning device for an aerial lift apparatus of claim 1 further comprising a microprocessor, memory and data storage for at least one of receiving, storing and transmitting data from the warning device.

21. A method of warning an aerial lift operator of movement of an aerial lift apparatus comprising the steps of:
detecting movement of an aerial lift apparatus using at least one movement detector that is attached non-invasively to the aerial lift apparatus without interfering with the electronics, hydraulics or other operational systems of the aerial lift apparatus;
receiving a signal from the at least one movement detector when movement is detected; and
activating a warning device when the signal is received to transmit a warning of movement to an operator of the aerial lift apparatus.

22. The method of warning an aerial lift operator of movement of an aerial lift apparatus of claim 21 further comprising the step of:
polling a plurality of safety sensor devices and equipment condition detectors in communication with the warning device to detect fault conditions; and
issuing a warning if a fault condition is detected.
